(19) United States
(12) Patent Application Publication
(10) Pub. No.: US 2024/0166120 A1
(43) Pub. Date: May 23, 2024

(54) Tailgate With An Integrated Grill

(71) Applicant: Timothy Peterson, Union Grove, WI (US)

(72) Inventor: Timothy Peterson, Union Grove, WI (US)

(21) Appl. No.: 18/426,908

(22) Filed: Jan. 30, 2024

Related U.S. Application Data
(63) Continuation of application No. 17/540,738, filed on Dec. 2, 2021.
(60) Provisional application No. 63/120,333, filed on Dec. 2, 2020.

(51) Int. Cl. B60P 3/36; A47J 37/07; B62D 33/027

(52) U.S. Cl. CPC B60P 3/36; A47J 37/0736; A47J 37/074; B62D 33/0273

(57) ABSTRACT

A tailgate having an integrated grill which includes multiple heating elements that are selected by an operator, as well as multiple storage compartments for storing cooking utensils and other items. The multiple storage compartments are disposed on each side of the integrated grill. The tailgate includes multiple types of heating elements that are secured within a rear storage area of the vehicle, such as gas burners and electric heating elements. The tailgate includes controls that are utilized to select between the different types of heating elements for different cooking options.

### CROSS-REFERENCE TO RELATED APPLICATIONS

This Continuation-In-Part application claims the benefit of U.S. Non-Provisional patent application Ser. No. 17/540,738, filed on Dec. 2, 2021, which claims the benefit of U.S. Provisional Patent Application Ser. No. 63/120,333, filed on Dec. 2, 2020. The above identified patent applications are herein incorporated by reference in their entirety to provide continuity of disclosure.

### BACKGROUND OF THE INVENTION

The present invention relates to a vehicle tailgate having accessory components, including grills and similar cooking devices. More particularly, the present invention provides a tailgate having an integrated grill which includes multiple heating elements that may be selected by an operator, as well as multiple storage compartments for storing cooking utensils and other items.

Vehicles with tailgate access to rear storage areas such as pickup trucks and Sport Utility Vehicles or SUVs are often used for recreational activities as well as transportation. Such vehicles provide maximal storage space for equipment and often provide additional utility once parked. Some of the recreational activities may include outdoor cooking with grills and the like. While pickup trucks and SUVs provide additional storage area for transporting grills and similar cooking devices, such devices are also bulky and heavy, making it difficult to load them into the vehicle without assistance. It may also be difficult to secure the grill or other cooking device within the vehicle such that it does not move around and damage itself or the vehicle during transport. Furthermore, the cooking devices will take-up space that may be otherwise used to store other items. The cooking device often also requires the storage of accessory items, such as utensils, for example, which further reduces the available storage space within the vehicle. Even if the vehicle may accommodate a large grill or other similar device, it may be difficult and time consuming to unload and reassemble the grill for use.

In order to address these concerns, the present invention provides a user with a truck tailgate equipped with a grill, a plurality of burners, and a plurality of other heating elements for cooking food, as well as a plurality of compartments for a plurality of utensils and other cooking accessories. Since the grill and other cooking elements are integrated within the vehicle tailgate, many of the above problems are remedied by the present invention.

Devices have been disclosed in the known art that relate to vehicle tailgates having integrated cooking mechanisms. These include devices that have been patented and disclosed in patent application publications. However, the devices in the known art have several drawbacks. For example, these typically only provide a single cooking element, which makes it difficult to prepare large quantities of food or foods that include different types of preparation. Further, the devices in the known art often lack the necessary storage compartments to store cooking utensils and other important items in close proximity to the cooking devices that are being utilized. Additionally, the devices in the known art typically provide only one fuel source, whereas the present invention may include multiple fuel sources that are selectable by the user, further adding to the overall utility of the present invention.

In light of the devices disclosed in the known art, it is submitted that the present invention substantially diverges in design elements from the known art, and consequently it is clear that there is a need in the art for an improvement to existing tailgates with an integrated grills. In this regard the present invention substantially fulfills these needs.

### SUMMARY OF THE INVENTION

The present invention relates to a vehicle tailgate having accessory components, including grills and similar cooking devices. More particularly, the present invention provides a tailgate having an integrated grill which includes multiple heating elements that may be selected by an operator, as well as multiple storage compartments for storing cooking utensils and other items.

The tailgate with an integrated grill generally includes a tailgate body pivotally secured to a rear end of a vehicle and an integrated grill disposed within an interior side of the tailgate body. The integrated grill includes a grill grate positioned above a first heating element, a plurality of controls for operating the first heating element, and a pair of compartments positioned adjacent opposing sides of the grill grate. A fuel supply is secured within a rear storage area of the vehicle. A fuel line coupled to the fuel supply extends through the interior side of the tailgate body and couples to the first heating element. The integrated grill may be utilized to prepare food quickly easily without requiring the transportation or assembly of a separate grill.

One object of the present invention is to provide a tailgate with an integrated grill that includes multiple accessory storage compartments for storing cooking utensils and other items so they are close at hand while cooking.

Another object of the present invention is to provide a tailgate with an integrated grill that includes multiple types of heating elements that are selectable by the user.

Another object of the present invention is to provide a tailgate with an integrated grill that includes multiple fuel sources that are selectable by the user.

A further object of the present invention is to provide a tailgate with an integrated grill that may be easily covered when not in use, allowing the tailgate to function as normal when needed.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a rear perspective view of an embodiment of a tailgate with a grill cover in an open position.

FIG. 2 shows a rear perspective view of an embodiment of the tailgate with the grill cover in a closed position.

FIG. 3 shows an overhead perspective view of an embodiment the tailgate with a first compartment and a plurality of controls.

FIG. 4 shows an overhead perspective view of an embodiment the tailgate with a plurality of removable grill grates and a second compartment.

FIG. 5 shows a rear perspective view of an embodiment the tailgate in the closed position.

FIG. 6 shows an overhead perspective view of an embodiment of the tailgate with the grill cover in the open position.

FIG. 7 shows a side perspective view of an embodiment of the tailgate with the grill cover in the open position.

### DETAILED DESCRIPTION OF THE INVENTION

Reference is made herein to the attached drawings. Like reference numerals are used throughout the drawings to depict like or similar elements of a tailgate with an integrated grill 100 (or tailgate 100). For the purposes of presenting a brief and clear description of the present invention, a preferred embodiment will be discussed as used for providing the tailgate 100. The figures are intended for representative purposes only and should not be considered to be limiting in any respect.

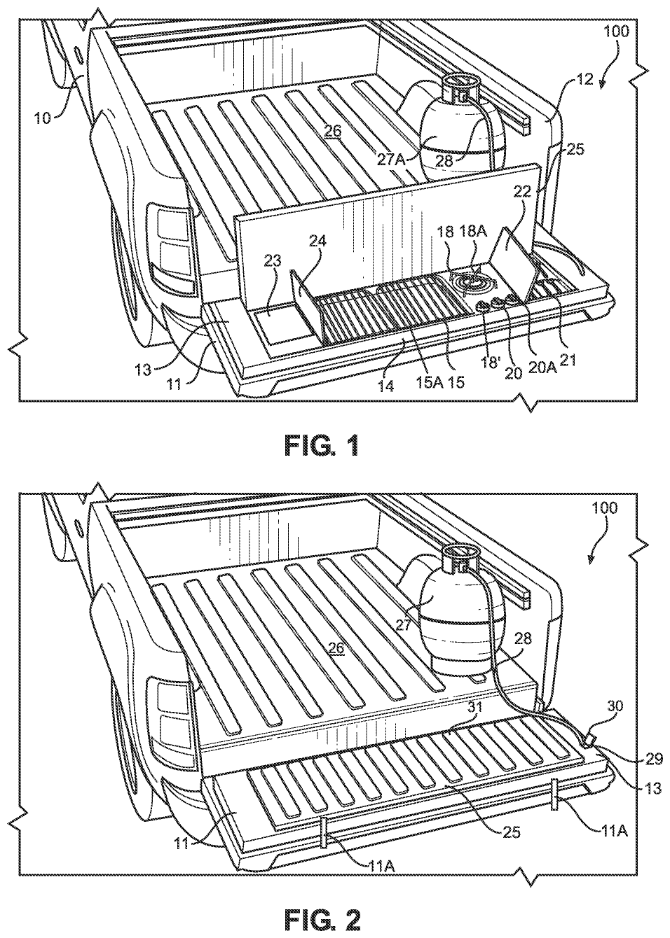

FIG. 1 shows a rear perspective view of an embodiment of a tailgate 100 with a grill cover 25 in an open position.

The tailgate 100 may include a tailgate body 11 pivotally secured to a rear end 12 of a vehicle 10. In the shown embodiment, the vehicle 10 may be a pickup truck or the like. However, any suitable type of vehicle 10 having a rear fold-down tailgate body 11 may be utilized, such as a Sport Utility Vehicle or SUV or the like. The tailgate body 11 may include a plurality of latches 11A or the like for securing the tailgate body 11 in a closed position, as with any rear fold-down vehicle tailgate body 11. In order to protect the tailgate body 11 from the heat generated by the integrated grill 14, the rear fold-down tailgate body 11 and other portions of the vehicle 10 may include a heat resistant paint as an outer covering or the like.

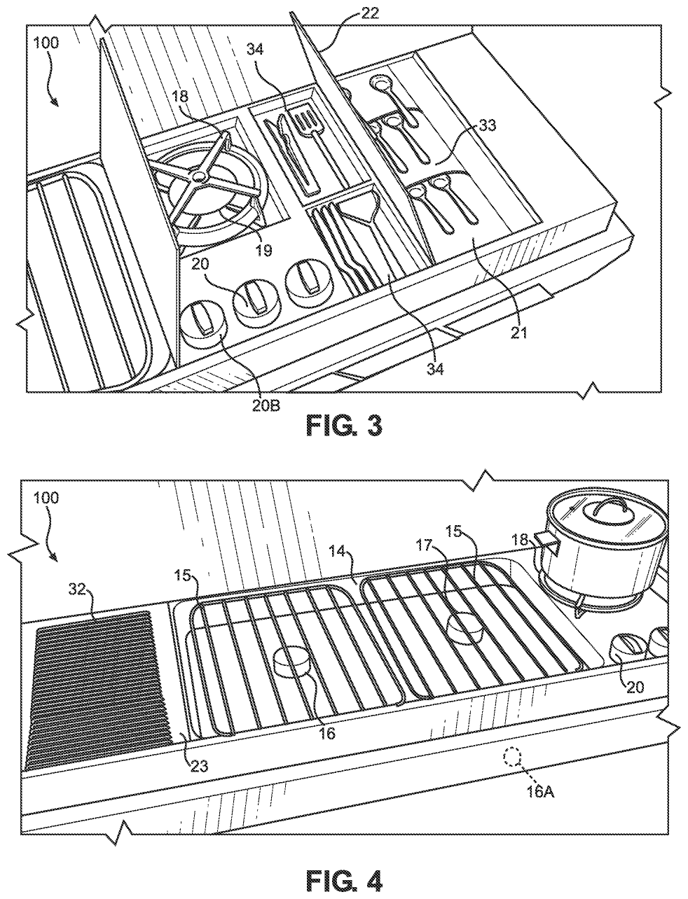

An integrated grill 14 may be disposed within an interior side 13 of the rear fold-down tailgate body 11. The integrated grill 14 may be integrated within the rear fold-down tailgate body 11 at manufacture or may be installed within a portion of the rear fold-down tailgate body 11 as an add-on. The integrated grill 14 may include at least one grill grate 15 positioned above a plurality of heating elements 16, 17, as most clearly visible in FIG. 4. The grill grates 15 may be shown as rack-type grates 15A, but may include different cooking surfaces, such as a flat-top griddle for example. The integrated grill 14 may include an additional heating element 18 adjacent the grill grates 15, which is shown as a gas burner 18A in the illustrated embodiment. A plurality of controls 20 are provided for operating the various cooking elements of the present invention. In the shown embodiment, the controls 20 include a plurality of rotatable knobs 20A, such as gas burner control knobs, for example, but the controls 20 may include any type or combination of buttons, knobs, and the like. The gas burner 18 and other gas-powered heating elements may include electric ignition mechanisms 18′, which may also be operated via the controls 20.

The integrated grill 14 may further include a pair of compartments 21,23 positioned on opposing sides of the grill grates 15. The compartments 21,23 that provide storage areas that are easily accessible by the operator of the integrated grill 14 even when they are actively cooking or otherwise using the integrated grill 14. Each of the compartments 21,23 may include a closure door 22, 24 that may close to cover the compartments 21,23 until the user needs to access their interiors. The integrated grill 14 may include a grill cover 25 that is attached to the tailgate body 11. The grill cover 25 may open to expose the integrated grill 14 for use, and close to cover and protect the integrated grill 14 when not in use.

A fuel supply 27 may be secured within a rear storage area 26 of the vehicle 10. In the shown embodiment, the fuel supply 27 may be a propane tank 27A or the like that is secured within the rear storage area 26. This positioning allows the user to easily swap out empty propane tank 27A with a filled propane tank 27A tank as needed. A fuel line 28 may couple to the fuel supply 27 and extends through the interior side 13 of the tailgate body 11 and couples to at least one of the heating elements 16,17. For example, the fuel line 28 provides propane from the propane tank 27A to fuel the gas burner 18.

FIG. 2 shows a rear perspective view of an embodiment of the tailgate 100 with the grill cover 25 in a closed position.

When the grill cover 25 is in the closed position, the tailgate 11 may be utilized as a typical tailgate. The grill cover 25 may include a plurality of gripping ridges 31 that facilitate traction when loading and unloading the rear storage area 26 of the vehicle 10, such as when changing the fuel supply 27, for example. The tailgate body 11 may further include a pivoting access door 30 attached to the interior side 13 of the tailgate body 11. The pivoting access door 30 may be configured to selectively provide access to a coupling element 29 for the fuel line 28. The coupling element 29 may connect to various internal lines that transport the fuel to the heating elements 16,17. When the fuel line 28 is disconnected from the coupling element 29, the access door 30 may be closed to cover and protect the coupling element 39. This allows the user to remove the fuel supply 27 and fuel line 28 if additional storage room within the rear storage area 26 of the vehicle 10 is needed.

FIG. 3 shows an overhead perspective view of an embodiment the tailgate 100 with a first compartment 21 and a plurality of controls 20.

In the illustrated embodiment, the first compartment 21 may include a pair of removable trays 34 that may support various items such as utensils or the like. The first compartment 21 may also include individual pockets 33 that support utensils or other items such that they are protected and organized. The pivoting lid 22 may be opened to access the first compartment 21 or closed to secure the items stored therein. In the shown embodiment, the integrated grill 14 may further comprise a stovetop burner 18 having a second heating element 19 operably connected to the fuel supply and the controls 20, and positioned adjacent the grill grate 15 on one side and the first compartment 21 on its other side.

FIG. 4 shows an overhead perspective view of an embodiment of the tailgate 100 detailing a plurality of removable grill grates 15 and a second compartment 23.

In the shown embodiment, the second compartment 23 may include a removable rack 32. The removable rack 32 may support food items or any other desired materials while keeping such materials close at hand for the user of the integrated grill 14. In the shown embodiment, the integrated grill 14 may include a pair of heating elements 16, 17 positioned beneath the grill grates 15. The depiction of the heating elements 16, 17 is representative in nature, and as such the physical construction of the heating elements 16, 17 may include any configuration adapted to heat and cook food supported on the grill grates 15. The grill grates 15 may be preferably removable so that they may be easily cleaned as needed.

In the shown embodiment, the first heating element 16 may include a gas burner or similar gas-powered heating element, while the other heating element 17 may include an electric heating element that is operably connected to a power supply. In one embodiment, the power supply may be a rechargeable battery 16A disposed within the tailgate body 11. In another embodiment, the power supply is a direct connection to the vehicle battery (not shown). In yet another embodiment, the power supply may be a hardwired connection to a wall outlet or similar AC or DC power source (not shown). In these embodiments, the controls 20 may include a heating element selection control 20B configured to select between the gas grill heating element 16, the electric grill heating element 17, and the gas burner 18. The controls 20 may also facilitate operation of any combination of the heating elements 16,17 simultaneously. This may provide the user with the option to select from the heating elements 16,17 depending on current circumstances. For example, if fuel is not readily available for the gas heating elements 16,17, the electric heating elements may be utilized. Likewise, if battery power is low and the rechargeable battery 16A is not currently able to be charged, the gas heating elements may be utilized. Overall, the present invention provides the user with the convenience of multiple types of cooking devices integrated into the vehicle tailgate, which further provides multiple storage compartments. In this way, the present invention gives individuals the ability to cook and prepare meals outdoors during recreational activities without the need for a separate cooking appliance.

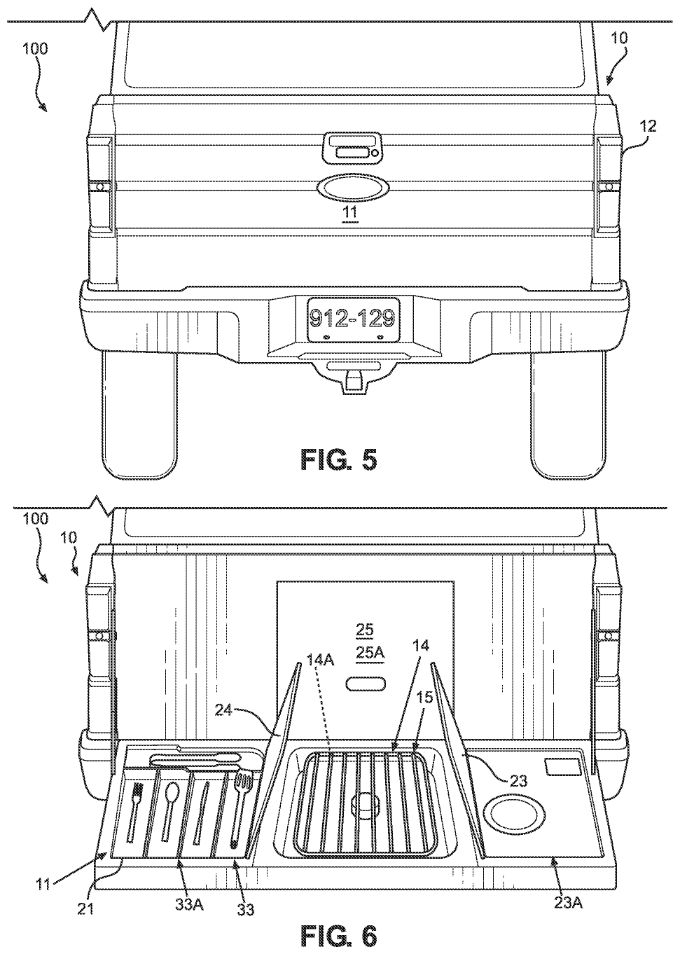

FIG. 5 shows a rear perspective view of an embodiment with the tailgate 100 in the closed position.

The tailgate 100 may include a tailgate body 11 pivotally secured to a rear end 12 of a vehicle 10. The tailgate body 11 may be made of heat-resistant metal or the like.

FIG. 6 shows an overhead perspective view of an embodiment of the tailgate 100 with the grill cover 25 in the open position.

The integrated grill 14 may include an aluminum foil pan 14A to catch any grease or residual cooking material from cooking on the integrated grill 14.

The grill cover 25 may be a heat resistant metal lid 25A that covers the tailgate 100.

The first compartment 21 may include a plurality of individual pockets 33 that support a plurality of utensils 33A or other items such that they are protected and organized. The second compartment 23 may also hold a plurality of necessities 23A such as paper plates, napkins and other necessities.

The grill cover 25 may fold-up and become a backsplash 25A for the grill grates 15.

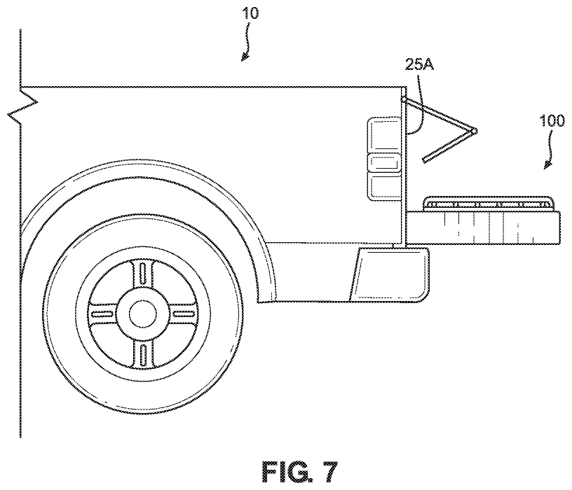

FIG. 7 shows a side perspective view of an embodiment of the tailgate 100 with the grill cover 25 in the open position.

The tailgate 100 may include a plurality of backsplash material disposed on the backsplash 25A that's made of durable waterproof material.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention. Therefore, the foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1. A tailgate, comprising:
a tailgate body pivotally secured to a rear end of a vehicle;
an integrated grill disposed within an interior side of the tailgate body, the integrated grill comprising a grill grate positioned above a first heating element, a plurality of controls for operating the first heating element, and a pair of compartments positioned adjacent opposing sides of the grill grate;
a fuel supply secured within a rear storage area of the vehicle; and
a fuel line coupled to the fuel supply that extends through the interior side of the tailgate body and couples to the first heating element.

2. The tailgate of claim 1, wherein the tailgate body includes a plurality of latches for securing the tailgate body in a closed position.

3. The tailgate of claim 1, wherein the grill grate is removable for cleaning purposes.

4. The tailgate of claim 1, wherein the fuel supply comprises a propane tank and the first heating element comprises a gas burner.

5. The tailgate of claim 1, further comprising a pivoting access door attached to the interior side of the tailgate body, the pivoting access door configured to provide access to a coupling element for the fuel line.

6. The tailgate of claim 1, wherein the integrated grill further comprises a stovetop burner having a second heating element operably connected to the fuel supply and positioned adjacent the removable grill grate.

7. The tailgate of claim 6, wherein the integrated grill comprises a third heating element which is an electric heating element operably connected to a battery power supply.

8. The tailgate of claim 7, wherein the battery power supply comprises a rechargeable battery disposed within the tailgate body.

9. The tailgate of claim 7, wherein the battery power supply is a main vehicle battery.

10. The tailgate of claim 7, wherein the controls includes a heating element selection control configured to select between the first heating element, the second heating element, and the third electrical element.

11. The tailgate of claim 1, wherein the pair of compartments comprises a first compartment having a first pivoting cover and a second compartment having a second pivoting cover.

12. The tailgate of claim 11, wherein the first compartment comprises a pair of recessed trays and a plurality of pockets adjacent the pair of recessed trays.

13. The tailgate of claim 12, wherein the second compartment comprises a removable rack.

14. The tailgate of claim 1, wherein the tailgate body includes a heat resistant paint as an outer covering.

15. The tailgate of claim 1, wherein the tailgate body is made of heat-resistant metal.

16. The tailgate of claim 1, wherein the integrated grill cover pivotally connected to the tailgate body and configured to move between a closed position covering the integrated grill and an open position exposing the integrated grill.

17. The tailgate of claim 16, further comprising an outer side of the integrated grill cover includes a plurality of ridges.

18. The tailgate of claim 16, wherein the integrated grill cover folds-up and become a backsplash for the grill grates.

19. The tailgate of claim 16, wherein the integrated grill is integrated within the tailgate body at manufacture or is installed within a portion of the rear fold-down tailgate body as an add-on.

20. The tailgate of claim 16, wherein the integrated grill includes an aluminum foil pan to catch any grease or residual cooking material from cooking on the integrated grill.
